(19) United States
(12) Patent Application Publication
(10) Pub. No.: US 2007/0250795 A1
(43) Pub. Date: Oct. 25, 2007

(54) Method of controlling display of options in user interface of moile communication device

(75) Inventor: Won Joo Park, Anyang-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/789,566

(22) Filed: Apr. 25, 2007

(30) Foreign Application Priority Data
Apr. 25, 2006 (KR) 2006-0036945

(51) Int. Cl. G06F 3/14

(52) U.S. Cl. 715/864

(57) ABSTRACT

A method for controlling a display of options in the user interface so as to hide or reveal some options not frequently used. The method includes determining whether all options in a list on a specific screen exceeds a give lines and determining whether an option to be hidden exists in the list. If an automatic hidden factor of an option satisfies a non-use criterion, the option is determined to be hidden. The option is then replaced with a folded mark, for example, and then hidden from the screen. When the folded mark is selected, the hidden option is revealed on the screen. The automatic hidden factor may be non-use times and a non-use period.

### PRIORITY

This U.S. application claims priority under 35 U.S.C. §119(a) to a Korean Patent Application No. 2006-36945 filed in the Korean Intellectual Property Office on Apr. 25, 2006, the contents of which are incorporated herein by reference.

### BACKGROUND OF THE INVENTION

1. Field of the Invention

The present invention relates generally to a user interface of a mobile communication device, and in particular, to a method for controlling a display of options in the user interface so as to hide or reveal some options not frequently used.

2. Description of the Related Art

A user interface of a mobile communication device, e.g., a mobile phone, provides interaction between a user and the device through a screen. Particularly, the user interface offers a menu, i.e., a list of options, on the screen, allowing a user to access and use various functions of the device.

Today, as mobile communication device features are enhanced, accessible options of the device are also increasing in number. However, the mobile device inherently has a relatively small display screen because of the size limitation needed for convenient carrying. As such, a list of options to be displayed may often exceed the area of the screen, and thus only parts of them are actually displayed on the screen. Therefore, if user chooses a certain option that cannot be displayed on the screen, the user simply scrolls the list of options so that the line of the wanted option may appear on the screen.

FIG. 1 shows a conventional scrolling of an option list displayed on a screen. The example shown in FIG. 1 illustrates that the number of actual options is greater than that of simultaneously displayable options. In this case, a user who wants to choose a non-appearing option has to move a focus 12 repeatedly via a navigation key 11. Unfortunately, the user is usually required to repeatedly scroll the options list displayed on the screen when there are many options to be displayed or when the screen is insufficient to display many options simultaneously.

### SUMMARY OF THE INVENTION

Accordingly, one aspect of the present invention is to provide a method of determining a list of rarely used options and then automatically hiding the options in a user interface of a mobile communication device.

Another aspect of the present invention is to provide a method of revealing hidden options in a user interface of a mobile communication device.

According to another aspect of the present invention, there is provided a method of controlling a display of options in a user interface of a mobile communication device. The method includes determining whether all options in a list on a specific screen exceeds a set of given lines; if the options exceed the given lines, determining whether an option to be hidden exists in the list; (c) if at least one option to be hidden exists in the list, hiding the at least one option from the screen; and (d) if all the options do not exceed the given lines or if there is no option to be hidden or after hiding the option from the screen, displaying the list on the screen.

Step (c) further includes replacing the hidden option with a folded mark, and displaying the folded mark at a position corresponding to the hidden option. Alternatively, Step (c) includes displaying message item at the end of the list, the message item informing presence of the hidden option.

In Step (a), the given lines correspond to the number of options that the screen can display at the same time.

Step (b) includes determining whether an automatic hidden factor of each option satisfies a predetermined non-use criterion such that a first option, satisfying the non-use criterion, is determined to be hidden and a second option, failing to satisfy the non-use criterion, is determined to be displayed. The automatic hidden factor includes at least one of non-use times and a non-use period. Additionally, Step (b) further includes determining whether the first option is a mandatory option such that the mandatory option is determined to be displayed.

Furthermore, the folded mark replaces continuously arranged plural options to be hidden. In this case, the folded mark may be positioned such that the location of a focus is not changed.

Step (c) further includes activating a visual animation. In addition, Step (c) further includes establishing the number of lines of the hidden option to one per folded mark.

The method further includes, after Step (d), choosing the folded mark; and revealing the hidden option replaced with the chosen folded mark on the screen. Alternatively, the method further includes after Step (d), choosing the message item; and revealing the hidden option on the screen.

The method further includes, after Step (d), selecting an option except a mandatory option; and hiding the selected option by receiving a user's input.

The method further includes, after Step (d), choosing an option; executing a function corresponding to the chosen option; and establishing the automatic hidden factor of the chosen option to zero.

The method further includes determining whether there is a used option in the screen when an executed application is terminated. If there is a used option in the screen, the automatic hidden factor of all the options except the used option in the screen may be increased. If there is no used option in the screen, the automatic hidden factor of all the options in the screen may be maintained.

### BRIEF DESCRIPTION OF THE DRAWINGS

The above and other objects, features and advantages of the present invention will become more apparent from the following detailed description when taken in conjunction with the accompanying drawing in which:

FIG. 1 is a screen view showing a conventional process of scrolling an option list.

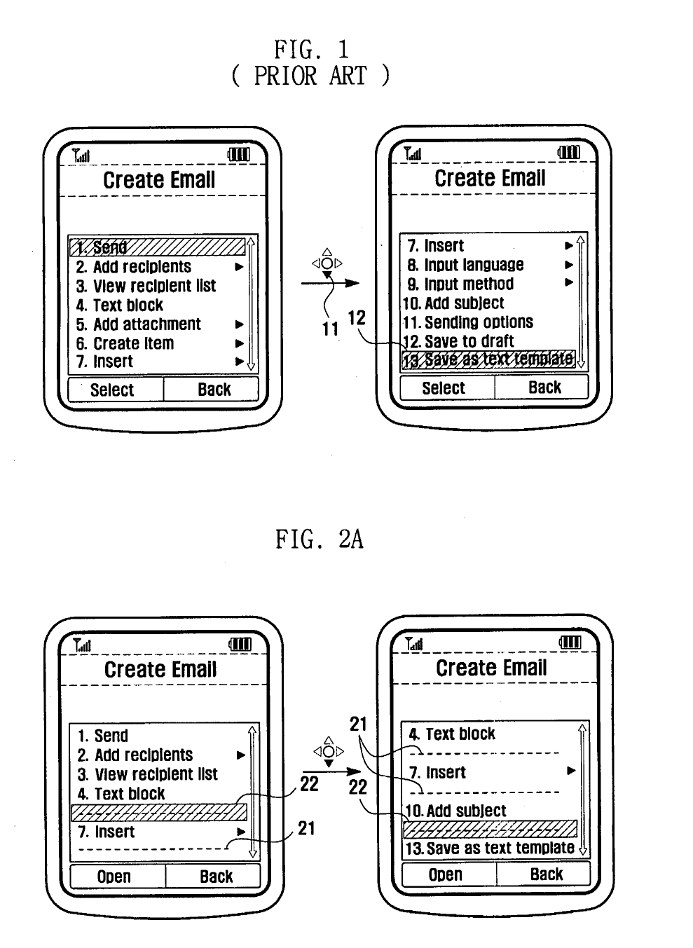

FIG. 2A is a screen view showing an option hiding state in accordance with an exemplary embodiment of the present invention.

FIG. 2B is a screen view showing an option revealing state in accordance with an exemplary embodiment of the present invention.

FIGS. 3A to 3C are flow diagrams illustrating a method of controlling a display of options in a user interface in accordance with an exemplary embodiment of the present invention.

FIG. 4 is a flow diagram illustrating a process of determining whether an option is used or not in accordance with an exemplary embodiment of the present invention.

FIGS. 5A to 5D are screen views showing option display setting in accordance with an exemplary embodiment of the present invention.

### DETAILED DESCRIPTION OF THE PREFERRED EMBODIMENTS

Exemplary embodiments of the present invention will now be described more fully hereinafter with reference to the accompanying drawings. The invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention. Well-known structures and processes are not described or illustrated in detail to avoid obscuring the essence of the present invention.

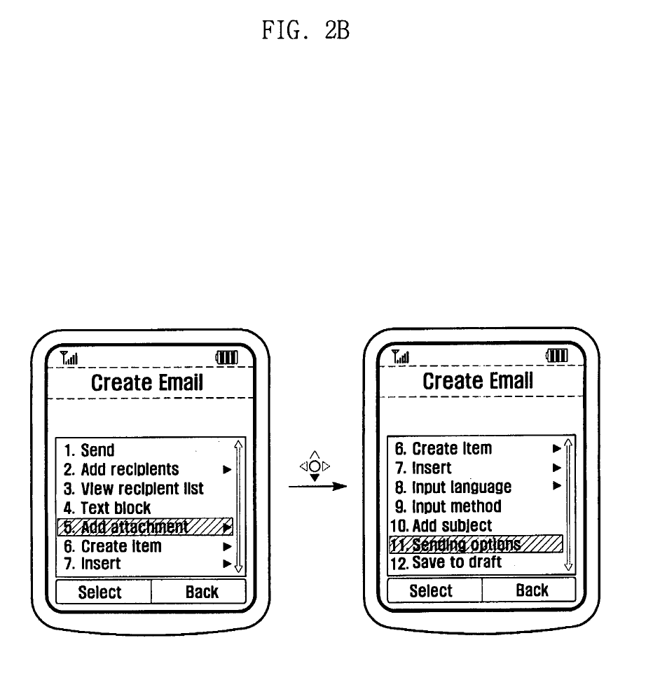

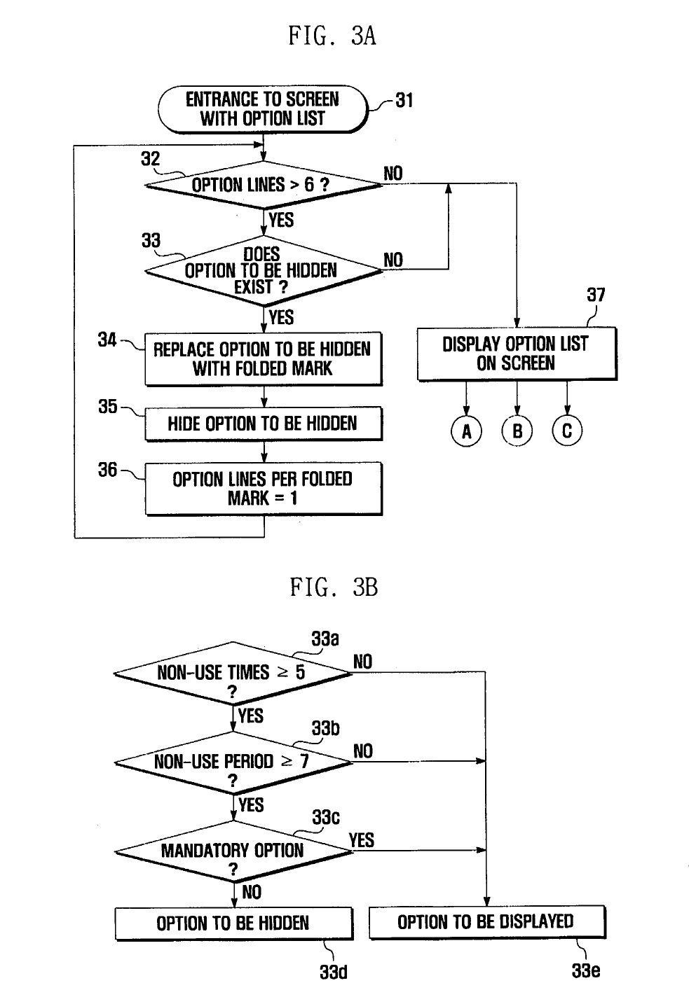

FIG. 2A shows, in a screen view, an option hiding state in accordance with an exemplary embodiment of the present invention.

In FIG. 2A, a user interface of a mobile communication device offers a menu, i.e., a list of options, on a screen. By choosing a specific one among various options in the user interface, a user can access and use a wanted function of the device.

In the option hiding state, the user interface does not offer all displayable options. That is, some options are displayed in the screen; others are hidden from the screen. For example, in FIG. 2A, 1^{st} to 4^{th}, 7^{th}, 10^{th} and 13^{th} options are displayed in the screen, whereas the other options are hidden and replaced by a folded mark 21.

Each option has an automatic hiding factor. When the automatic hiding factor of a certain option exceeds a predetermined non-use criterion, that option is automatically hidden from the screen. If necessary, a user may manually hide an option regardless of the non-use criterion.

The displayed options are predefined mandatory options or frequently used options. On the other hand, the hidden options are rarely used options. The mandatory option is always displayed even though not used at all. Further, a user cannot hide the mandatory option even manually. Every screen in the user interface always involves at least one mandatory option so as to offer the lowest information of an executable task. The frequently used option and the rarely used option are determined according to their automatic hiding factors. The automatic hiding factor of the frequently used option does not satisfy the non-use criterion, while the rarely used option satisfies the non-use criterion.

The automatic hiding factor includes the number of non-use times and a period of non-use. And the non-use criterion is a predetermined value on which a decision about option hiding is based. For example, if the non-use criterion is established to be five times and seven days, an option that has five or more non-use times and seven or more non-use days is automatically hidden. The automatic hiding factor may be checked by real-time operation software.

If a user moves a focus 22 to the folded mark 21 and presses a selection key, the hidden option or options are revealed at a location of the selected folded mark 21. FIG. 2B shows, in a screen view, an option revealing state in accordance with an exemplary embodiment of the present invention.

The following rules are applied to a method of controlling a display, i.e., hiding or revealing, of options according to the present invention.

Rule 1. When the mobile device is used for the first time, all options should be displayed in a list.

Rule 2. Unless a user selects a certain option, a sub-depth option of the option will not be displayed.

Rule 3. If a certain option is not used m times or more (e.g., five times) and n days or more (e.g., seven days), the option is determined to be hidden.

Rule 4. Once a certain option is used, the automatic hidden factor thereof is set to zero and the used option is excluded from the hidden option.

Rule 5. Use of an option means that an option is selected and a corresponding function is executed. To only reveal a hidden option or to only display a sub-depth option by selecting an option is not regarded as use of an option.

Rule 6. If a certain application is executed and at least one option is used at a specific-depth screen, the other options on the same screen are regarded as being not used one time regardless of the number of used options and the number of use times when the application is terminated. All options except used option have an increase of one in automatic hidden factor.

Rule 7. If there is no option used in a specific-depth screen, the number of non-use times of all options on the same screen is not increased.

Rule 8. When a user enters a specific-depth screen, an option or options determined to be hidden are hidden from a list. In case continuously arranged options are hidden, the options are replaced by a single folded mark.

Rule 9. If the sum of displayed options and folded marks does not exceed the given number of lines (e.g., six lines) in a specific-depth screen, all options, even determined to be hidden, are not hidden.

Rule 10. Every screen in the user interface should involve at least one mandatory option that offers the lowest information of an executable task.

Rule 11. All options except the mandatory option can be manually hidden.

Rule 12. If a folded mark is selected, an option or options replaced by the selected folded mark are revealed.

Rule 13. When hidden options are revealed, the revealed options follow the original arrangement.

Rule 14. When options are hidden or revealed, a list of options is automatically scrolled such that the location of a focus is not changed.

Rule 15. When options are hidden or revealed, an animation is activated so as to give visual impressions of unfolding or folding.

Rule 16. Even though an option is not used, the automatic hidden factor of the option may be set to zero in case the state of the option is turned into a non-available state represented by gray.

The above rules are exemplary only and not to be considered as a limitation of exemplary embodiments of the present invention.

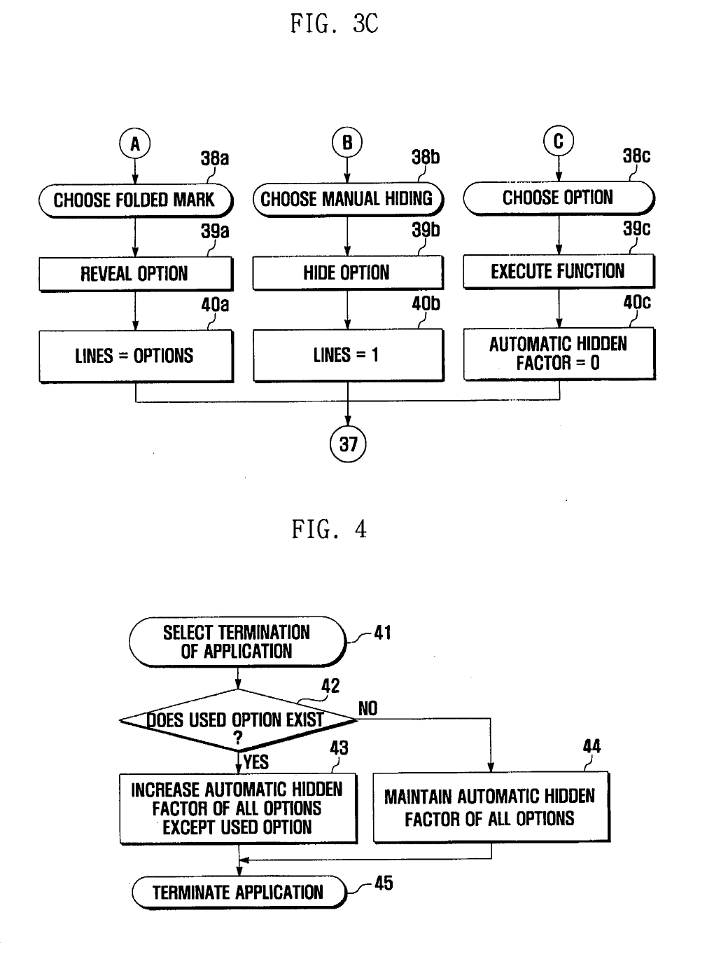

FIGS. 3A to 3C are flow diagrams that illustrate a method of controlling a display of options in a user interface in accordance with an exemplary embodiment of the present invention.

In FIG. 3A, after entering into a specific-depth screen having a list of options in step 31, a user interface controller of the mobile communication device determines whether all options in the list exceeds six lines in step 32. The above-discussed Rule 9 is applied to this step 32. If the options do not exceed six lines, all the options can be simultaneously displayed in the screen. Thus, this case does not require hiding options. The number of lines (e.g., six lines) corresponds to the number of options that the screen can display at the same time. The number of displayable options may vary according to a size of a display unit.

If the number of options exceeds six, the user interface controller determines, in step 33, whether an option determined to be hidden exists in the list. This step 33 has sub-steps shown below in FIG. 3B.

In FIG. 3B, the user interface controller determines whether the number of non-use times of each option is five or more times in step 33a and whether a period of non-use of each option is seven or more days in step 33b. The above-discussed Rule 3 is applied to these steps 33a and 33b. Five times and seven days in these steps 33a and 33b are example of the above discussed non-use criterion and not to be considered as a limitation of an exemplary embodiment of the present invention. Additionally, only one of the non-use times and the non-use period may be used as the non-use criterion.

Each option that satisfies the non-use criterion in steps 33a and 33b is then determined whether to be a mandatory option in step 33c. An option or options that satisfy the non-use criterion and are not mandatory options are determined to be hidden in step 33d. On the other hand, an option or options that fail to satisfy the non-use criterion or are mandatory options are determined to be displayed in step 33e.

In FIG. 3A, if an option or options determined to be hidden exist in the list, such options are replaced with a folded mark in step 34 according to the above discussed Rule 8. The option to be hidden may be a single one or plural ones. Further, plural options to be hidden may be continuously or discontinuously arranged. A single option or continuously arranged options are replaced with a single folded mark, whereas discontinuously arranged options are replaced with corresponding numbers of folded marks. In case of the continuously arranged options, the location of the folded mark is fixed such that the above-discussed Rule 14 is satisfied.

In step 35, the user interface controller hides an option or options determined to be hidden. At this time, an animation may be activated according to the above-discussed Rule 15.

In step 36, the user interface controller establishes the number of lines of the hidden options to one per folded mark, and then returns to the previous step 32.

If options in the list do not exceed six lines in step 32 or if there is no option to be hidden in step 33, the user interface controller displays the list of options on the screen in step 37.

After step 37, three choices are possible as shown in FIG. 3C.

First, a folded mark may be chosen in step 38a. In this case, according to the above-discussed Rule 12, an option or options replaced by the folded mark are revealed on the screen in step 39a. Here, Rules 13 to 15 are also applied to this step 39a. After the options are revealed, the number of lines is established again to the same as the number of options in step 40a.

Second, a manual hiding may be chosen in step 38b. In this case, according to the above-discussed Rule 11, an option or options except the mandatory option are selected and manually hidden by means of a user's input in step 39b. Here, the number of hidden option lines becomes one in step 40b.

Third, a certain option may be chosen in step 38c. In this case, a function corresponding to the chosen option is executed in step 39c. Then, according to the above-discussed Rules 4 and 5, the automatic hidden factor of the executed option is reestablished to zero in step 40c.

A process on how to hide or reveal options has been described above. Described below is a process on how to determine use and non-use of options for option hiding or revealing.

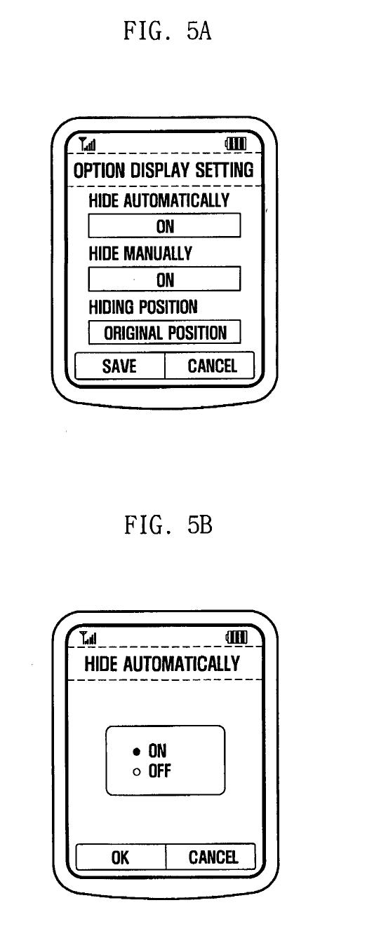

FIG. 4 is a flow diagram that illustrates a process of determining whether an option is used or not in accordance with an exemplary embodiment of the present invention.

In FIG. 4, if the termination of a currently executed application is selected in step 41, the user interface controller determines whether there exists a used option among options of the current application in step 42.

If there is a used option, in step 43, the controller increases the automatic hidden factor of all options except the used option in a specific-depth screen to which the used option belongs according to the above-discussed Rules 5 and 6. Once a certain option is selected and corresponding function is executed, the option is regarded as being used and the other options in the same screen are regarded as being not used.

Conversely, if there is no used option, the controller does not increase the automatic hidden factor of all options according to the above-discussed Rule 7 in step 44. If there is no used option, all options are neither to have been used nor to have been not used. So every automatic hidden factor is maintained.

After increasing or maintaining the automatic hidden factor, the user interface controller terminates the current application in step 45.

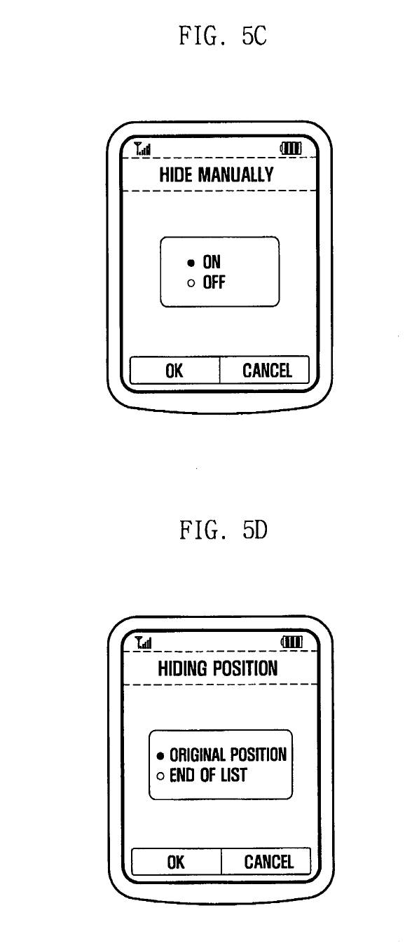

The option display can be set by a user. FIGS. 5A to 5D are screen views that show option display setting in accordance with an exemplary embodiment of the present invention. Specifically, FIG. 5A shows a main menu of the option display setting.

As further shown in FIG. 5A, a main menu of the option display setting has items for setting an automatic hiding function and a manual hiding function, respectively. A user can set a function of hiding automatically to on or off as shown in FIG. 5B. Likewise, a user can set a function of hiding manually to on or off as shown in FIG. 5C.

The main menu of the option display setting further has an item for setting a hiding position. As shown in FIG. 5D, the hiding position is an original position or the end of a list. In former case, the above-discussed folded mark replaces hidden options at an original position of the hidden options. In latter case, options are hidden without a folded mark. Instead, message item such as ‘More Options’ is displayed at the end of the option list. When a user selects the message item, the hidden options are revealed at their respective original positions.

As discussed above, the method of controlling a display of options in a user interface, according to the present invention, determines which options are rarely used and then automatically hides these rarely used options. Furthermore, the controlling method of the present invention can also conveniently reveal the hidden options. Hence, such a hiding and revealing method can greatly enhance the usability of the user interface of a mobile communication device.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of controlling a display of options in a user interface of a mobile communication device, the method comprising steps of:
(a) determining whether all options in a list on a specific screen exceeds a given the number of lines;
(b) if the options exceed the given the number of lines, determining whether an option to be hidden exists in the list;
(c) if at least one option to be hidden exists in the list, hiding at least one option from the screen; and
(d) if all the options do not exceed the given the number of lines or if there is no option to be hidden, or after hiding the option from the screen, displaying the list on the screen.

2. The method of claim 1, wherein step (c) further includes replacing the hidden option with a folded mark, and displaying the folded mark at a position corresponding to the hidden option.

3. The method of claim 1, wherein step (c) further includes displaying a message item at the end of the list, the message item informing the presence of the hidden option.

4. The method of claim 1, wherein step (a) the given the number of lines correspond to the number of options that the screen can display at the same time.

5. The method of claim 1, wherein step (b) includes determining whether an automatic hidden factor of each option satisfies a non-use criterion such that a first option satisfying the non-use criterion is determined to be hidden and a second option failing to satisfy the non-use criterion is determined to be displayed.

6. The method of claim 5, wherein the automatic hidden factor includes at least one of non-use times and a non-use period.

7. The method of claim 5, wherein step (b) further includes determining whether the first option is a mandatory option such that the mandatory option is determined to be displayed.

8. The method of claim 2, wherein the folded mark replaces continuously arranged plural options to be hidden.

9. The method of claim 8, wherein the folded mark is positioned such that the location of a focus is not changed.

10. The method of claim 1, wherein step (c) includes activating a visual animation.

11. The method of claim 1, wherein step (c) includes establishing the number of lines of the hidden option to one per folded mark.

12. The method of claim 2, further comprising steps of:
after step (d), choosing the folded mark; and
revealing the hidden option replaced with the chosen folded mark on the screen.

13. The method of claim 3, further comprising steps of:
after step (d), choosing the message item; and
revealing the hidden option on the screen.

14. The method of claim 1, further comprising steps of:
after step (d), selecting an option except a mandatory option; and
hiding the selected option by receiving a user's input.

15. The method of claim 5, further comprising steps of:
after step (d), choosing an option;
executing a function corresponding to the chosen option; and
establishing the automatic hidden factor of the chosen option to zero.

16. The method of claim 1, wherein the list has at least one mandatory option.

17. The method of claim 5, further comprising a step of:
determining whether there is a used option in the screen when an executed application is terminated.

18. The method of claim 17, wherein if there is a used option in the screen, the automatic hidden factor of all the options except the used option in the screen is increased, and if there is no used option in the screen, the automatic hidden factor of all the options in the screen is maintained.
